(19) United States
(12) Patent Application Publication
(10) Pub. No.: US 2025/0036755 A1
(43) Pub. Date: Jan. 30, 2025

(54) VISUALIZING UNAUTHORIZED ACCESS TACTICS USED TO ACCESS MACHINES LOCATED ON INDUSTRIAL FLOOR

(71) Applicant: International Business Machines Corporation, Armonk, NY (US)

(72) Inventors: Sarbajit K. Rakshit, Kolkata (IN); Jagabondhu Hazra, Bangalore (IN); Manikandan Padmanaban, Chennai (IN)

(21) Appl. No.: 18/226,146

(22) Filed: Jul. 25, 2023

(51) Int. Cl. G06F 21/55

(52) U.S. Cl. CPC G06F 21/554; G06F 2221/034

(57) ABSTRACT

Described are techniques for visualizing unauthorized access or attempted unauthorized access of the machines located on an industrial floor. Log files from the firewall monitoring traffic to and from the machines located on the industrial floor of the industrial facility are captured. The captured log files are then analyzed to identify the behavior used in accessing or attempting to access the machine(s) located on the industrial floor of the industrial facility. Furthermore, a knowledge base for unauthorized access tactics is analyzed. An augmented reality visualization may then be created to illustrate the unauthorized access tactic being performed on the machine(s) located on the industrial floor if the identified behavior is within a threshold degree of similarity to the unauthorized access tactic learned from the knowledge base. In this manner, machine operators will now be effectively informed of attempts to gain unauthorized access to the machines located on the industrial floor.

### TECHNICAL FIELD

The present disclosure relates generally to unauthorized access, and more particularly to unauthorized access or attempt to access machines (e.g., robots, computer numerical control machine tools, automated guided vehicles) located on the industrial floor.

### BACKGROUND

Unauthorized access is when a person gains entry to a computer network, system, application software, data, or other resources without permission. Any access to an information system or network that violates the owner or operator's stated security policy is considered unauthorized access. Unauthorized access is also when legitimate users access a resource that they do not have permission to use.

In the context of the manufacturing industry, various machines (e.g., robots, computer numerical control machine tools, automated guided vehicles, etc.) located on the industrial floor (floor, such as concrete, used in industrial and commercial settings) are used to manufacture and produce parts, goods, pieces, etc., such as in a plant, factory, etc. For example, such machines may correspond to robots that weld and assemble parts. In another example, computer numerical control machines cut metal pieces to precise specification. In a further example, engine machining stations are used to create engine blocks.

Users (referred to as “security hackers”) may attempt to gain unauthorized access to such machines located on the industrial floor to steal sensitive data, cause damage, hold data hostage as part of a ransomware attack, play a prank, etc. For example, a security hacker may attempt to gain unauthorized access to a computer numerical control machine tool to manipulate the machine's programming to cause it to create defective parts. If the machine's operator does not notice the problem in time, then those defective parts will enter the market. In another example, a security hacker may attempt to gain unauthorized access to a computer numerical control machine tool to gain a competitive advantage by stealing confidential, proprietary information.

There are various means for a security hacker to attempt to gain unauthorized access to machines located on the industrial floor, such as exploiting software vulnerabilities. Other means include social engineering tactics, such as phishing, smishing, spear phishing, ransomware, etc. Furthermore, security hackers may utilize malware (malicious software) to gain unauthorized access to the machines located on the industrial floor, including information stored on such machines. Malware is software intentionally designed to gain unauthorized access to information or systems, such as machines located on the industrial floor. Examples of such malware include computer viruses, worms, Trojan horses, ransomware, spyware, rogue software, etc.

Unfortunately, there is not currently a means for effectively informing the machine operators, such as visually, of such attempts to gain unauthorized access to the machines located on the industrial floor. Such machine operators need to have knowledge of which machines on the industrial floor are being attempted to be accessed without permission or have actually been accessed without permission in order for the machine operators to take remedial action to address such attempted or successful unauthorized access of the machines located on the industrial floor.

### SUMMARY

In one embodiment of the present disclosure, a computer-implemented method for visualizing unauthorized access or attempted unauthorized access of machines located on an industrial floor comprises capturing log files from a firewall monitoring traffic to and from the machines located on the industrial floor. The method further comprises analyzing the log files from the firewall to identify a behavior used in accessing or attempting to access one or more machines of the machines located on the industrial floor. The method additionally comprises analyzing a knowledge base for unauthorized access tactics. Furthermore, the method comprises creating an augmented reality visualization to illustrate an unauthorized access tactic being performed on the one or more machines located on the industrial floor in response to the identified behavior being associated with the unauthorized access tactic within a threshold degree of similarity based on the analysis of the knowledge base.

Furthermore, in one embodiment of the present disclosure, the method additionally comprises analyzing log files from the one or more machines located on the industrial floor to identify operational parameters.

Additionally, in one embodiment of the present disclosure, the method further comprises creating the augmented reality visualization to illustrate the unauthorized access tactic being performed on the one or more machines located on the industrial floor using the identified operational parameters.

Furthermore, in one embodiment of the present disclosure, the method additionally comprises creating one or more avatars of a security hacker and/or a detected malware. Furthermore, the method comprises illustrating the unauthorized access tactic being performed on the one or more machines located on the industrial floor in the augmented reality visualization using the created one or more avatars.

Additionally, in one embodiment of the present disclosure, the method further comprises identifying a remedial action to address the unauthorized access tactic being performed on the one or more machines located on the industrial floor using the knowledge base. Furthermore, the method comprises illustrating the identified remedial action to address the unauthorized access tactic being performed on the one or more machines in the augmented reality visualization.

Furthermore, in one embodiment of the present disclosure, the method additionally comprises receiving feedback regarding the augmented reality visualization. Additionally, the method comprises updating the knowledge base for unauthorized access tactics based on the feedback.

Additionally, in one embodiment of the present disclosure, the augmented reality visualization is displayed on augmented reality smart glasses.

Other forms of the embodiments of the computer-implemented method described above are in a system and in a computer program product.

In this manner, machine operators will now be effectively informed of attempts to gain unauthorized access to the machines located on the industrial floor, such as via an augmented reality visualization. As a result, machine operators will now have knowledge of the machines on the industrial floor that are being attempted to be accessed without permission or have actually been accessed without permission thereby allowing the machine operators to take remedial action to address such attempted or successful unauthorized access of the machine(s).

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 is a diagram of the software components used by the unauthorized access detector for visualizing unauthorized access tactics to access or attempt to access the machines located on the industrial floor of the industrial facility in accordance with an embodiment of the present disclosure;

FIG. 3 illustrates an embodiment of the present disclosure of the hardware configuration of the unauthorized access detector which is representative of a hardware environment for practicing the present disclosure;

FIG. 4 is a flowchart of a method for visualizing unauthorized access or attempted unauthorized access of the machines located on the industrial floor of the industrial facility in accordance with an embodiment of the present disclosure;

FIG. 5 is a flowchart of a method for creating an augmented reality visualization in accordance with an embodiment of the present disclosure; and

FIG. 6 is a flowchart of a method for updating the knowledge base with received feedback regarding the augmented reality visualization in accordance with an embodiment of the present disclosure.

### DETAILED DESCRIPTION

In one embodiment of the present disclosure, a computer-implemented method for visualizing unauthorized access or attempted unauthorized access of machines located on an industrial floor comprises capturing log files from a firewall monitoring traffic to and from the machines located on the industrial floor. The method further comprises analyzing the log files from the firewall to identify a behavior used in accessing or attempting to access one or more machines of the machines located on the industrial floor. The method additionally comprises analyzing a knowledge base for unauthorized access tactics. Furthermore, the method comprises creating an augmented reality visualization to illustrate an unauthorized access tactic being performed on the one or more machines located on the industrial floor in response to the identified behavior being associated with the unauthorized access tactic within a threshold degree of similarity based on the analysis of the knowledge base.

In this manner, machine operators will now be effectively informed of attempts to gain unauthorized access to the machines located on the industrial floor, such as via an augmented reality visualization. As a result, machine operators will now have knowledge of the machines on the industrial floor that are being attempted to be accessed without permission or have actually been accessed without permission thereby allowing the machine operators to take remedial action to address such attempted or successful unauthorized access of the machine(s).

Furthermore, in one embodiment of the present disclosure, the method additionally comprises analyzing log files from the one or more machines located on the industrial floor to identify operational parameters.

In this manner, operational parameters of the machines located on the industrial floor are identified by analyzing the log files from the machines.

Additionally, in one embodiment of the present disclosure, the method further comprises creating the augmented reality visualization to illustrate the unauthorized access tactic being performed on the one or more machines located on the industrial floor using the identified operational parameters.

In this manner, an augmented reality visualization is created that illustrates the unauthorized access tactic being performed on the machines located on the industrial floor using the operational parameters of such machines.

Furthermore, in one embodiment of the present disclosure, the method additionally comprises creating one or more avatars of a security hacker and/or a detected malware. Furthermore, the method comprises illustrating the unauthorized access tactic being performed on the one or more machines located on the industrial floor in the augmented reality visualization using the created one or more avatars.

In this manner, the unauthorized access tactic being performed on the machines located on the industrial floor is illustrated using avatars of a security hacker and/or a detected malware.

Additionally, in one embodiment of the present disclosure, the method further comprises identifying a remedial action to address the unauthorized access tactic being performed on the one or more machines located on the industrial floor using the knowledge base. Furthermore, the method comprises illustrating the identified remedial action to address the unauthorized access tactic being performed on the one or more machines in the augmented reality visualization.

In this manner, a remedial action to address the unauthorized access tactic being performed on the machines located on the industrial floor is illustrated in the augmented reality visualization.

Furthermore, in one embodiment of the present disclosure, the method additionally comprises receiving feedback regarding the augmented reality visualization. Additionally, the method comprises updating the knowledge base for unauthorized access tactics based on the feedback.

In this manner, the knowledge base for unauthorized access tactics is updated to improve the accuracy of the unauthorized access tactics stored in the knowledge base, such as those tactics used by the security hackers, and/or the remedial actions to address the unauthorized access tactics.

Additionally, in one embodiment of the present disclosure, the augmented reality visualization is displayed on augmented reality smart glasses.

In this manner, the augmented reality visualization is displayed on augmented reality smart glasses.

Other forms of the embodiments of the computer-implemented method described above are in a system and in a computer program product.

As stated above, in the context of the manufacturing industry, various machines (e.g., robots, computer numerical control machine tools, automated guided vehicles, etc.) located on the industrial floor (floor, such as concrete, used in industrial and commercial settings) are used to manufacture and produce parts, goods, pieces, etc., such as in a plant, factory, etc. For example, such machines may correspond to robots that weld and assemble parts. In another example, computer numerical control machines cut metal pieces to precise specification. In a further example, engine machining stations are used to create engine blocks.

Users (referred to as “security hackers”) may attempt to gain unauthorized access to such machines located on the industrial floor to steal sensitive data, cause damage, hold data hostage as part of a ransomware attack, play a prank, etc. For example, a security hacker may attempt to gain unauthorized access to a computer numerical control machine tool to manipulate the machine's programming to cause it to create defective parts. If the machine's operator does not notice the problem in time, then those defective parts will enter the market. In another example, a security hacker may attempt to gain unauthorized access to a computer numerical control machine tool to gain a competitive advantage by stealing confidential, proprietary information.

There are various means for a security hacker to attempt to gain unauthorized access to machines located on the industrial floor, such as exploiting software vulnerabilities. Other means include social engineering tactics, such as phishing, smishing, spear phishing, ransomware, etc. Furthermore, security hackers may utilize malware (malicious software) to gain unauthorized access to the machines located on the industrial floor, including information stored on such machines. Malware is software intentionally designed to gain unauthorized access to information or systems, such as machines located on the industrial floor. Examples of such malware include computer viruses, worms, Trojan horses, ransomware, spyware, rogue software, etc.

Unfortunately, there is not currently a means for effectively informing the machine operators, such as visually, of such attempts to gain unauthorized access to the machines located on the industrial floor. Such machine operators need to have knowledge of which machines on the industrial floor are being attempted to be accessed without permission or have actually been accessed without permission in order for the machine operators to take remedial action to address such attempted or successful unauthorized access of the machines located on the industrial floor.

The embodiments of the present disclosure provide a means for effectively informing the machine operators of attempts to gain unauthorized access to the machines located on the industrial floor. In one embodiment, such machine operators are informed of such attempts to gain unauthorized access by creating an augmented reality visualization to illustrate an unauthorized access tactic being performed on the machine(s) located on the industrial floor. Such an augmented reality visualization is created based on analyzing log files from a firewall monitoring traffic to and from the machines located on the industrial floor. Such log files may be analyzed to identify the behavior used in accessing or attempting to access the machine(s) located on the industrial floor. A knowledge base for storing previously identified unauthorized access tactics is then analyzed to determine if the identified behavior is within a threshold degree of similarity to an unauthorized access tactic previously identified in the knowledge base. If the identified behavior is within the threshold degree of similarity to an unauthorized access tactic previously identified in the knowledge base, then the log files from the machines (determined from the identified behavior) located on the industrial floor that were accessed or attempted to be accessed in an unauthorized manner are analyzed to identify the operational parameters (e.g., cutting speed, coolant temperature) of such machines. The augmented reality visualization is then created to illustrate the unauthorized access tactic being performed on the machine(s) located on the industrial floor using the identified operational parameters of such machine(s). A further discussion regarding these and other features is provided below.

In some embodiments of the present disclosure, the present disclosure comprises a computer-implemented method, system, and computer program product for visualizing unauthorized access or attempted unauthorized access of the machines located on an industrial floor. In one embodiment of the present disclosure, log files from the firewall monitoring traffic to and from the machines located on the industrial floor of the industrial facility are captured. The captured log files are then analyzed to identify the behavior used in accessing or attempting to access one or more machines located on the industrial floor of the industrial facility. “Behavior,” as used herein, refers to the actions being performed, such as by a security hacker, in accessing or attempting to access the machine(s) located on the industrial floor of the industrial facility.

Furthermore, a knowledge base for unauthorized access tactics is analyzed. A “knowledge base,” as used herein, refers to a collection of data that contains information pertaining to unauthorized access tactics that were previously used, such as by security hackers, to access the machine(s) located on the industrial floor of the industrial facility in an unauthorized manner. An augmented reality visualization may then be created to illustrate the unauthorized access tactic being performed on the machine(s) located on the industrial floor of the industrial facility if the identified behavior is within a threshold degree of similarity to the unauthorized access tactic learned from the knowledge base. In this manner, machine operators will now be effectively informed of attempts to gain unauthorized access to the machines located on the industrial floor, such as via the augmented reality visualization. As a result, machine operators will now have knowledge of the machines on the industrial floor that are being attempted to be accessed without permission or have actually been accessed without permission thereby allowing the machine operators to take remedial action to address such attempted or successful unauthorized access of the machine(s).

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

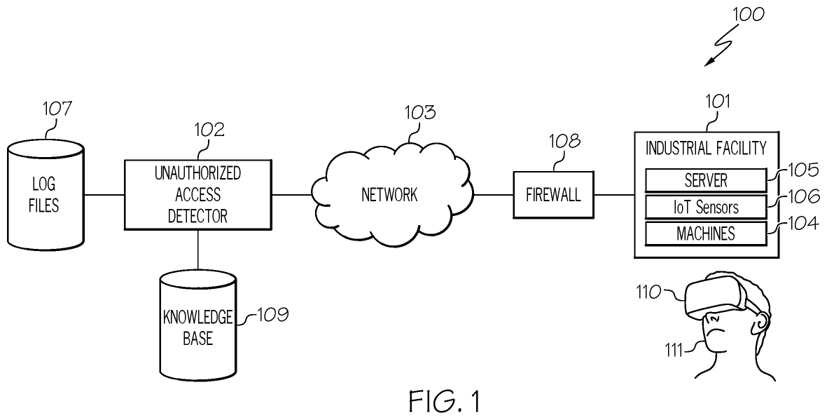

Referring now to the Figures in detail, FIG. 1 illustrates an embodiment of the present disclosure of a communication system 100 for practicing the principles of the present disclosure. Communication system 100 includes an industrial facility 101 connected to an unauthorized access detector 102 via a network 103 and a firewall 108.

An “industrial facility” 101, as used herein, refers to a complex (e.g., manufacturing plant) which may consist of one or more buildings that include one or more machines 104 located on the industrial floor (floor, such as concreted, used in industrial and commercial settings) of industrial facility 101. Such machines 104 are used to manufacture and produce parts, goods, pieces, etc. in industrial facility 101. Examples of such machines 104 include robots, computer numerical control machine tools, automated guided vehicles, etc. For example, such machines may correspond to robots that weld and assemble parts. In another example, computer numerical control machines cut metal pieces to precise specification. In a further example, engine machining stations are used to create engine blocks.

In one embodiment, each machine 104 is uniquely identified via a serial number which is stored in a data structure (e.g., table) residing in a storage device of server 105 (discussed further below). In one embodiment, such serial numbers are linked to a type of machine (e.g., grinder) in such a data structure (e.g., table). In one embodiment, such a data structure is populated by an expert.

In the illustration of FIG. 1, the interconnection of industrial facility 101 to unauthorized access detector 102 via network 103 and firewall 108 is accomplished via server 105.

In one embodiment, server 105 controls the operations of machines 104, such as via automation software. “Automation software,” as used herein, refers to applications that minimize the need for human input and are designed to turn repeatable, routine tasks into automated actions. For example, server 105 utilizes automation software for controlling the operations of machines 104, such as loading and unloading parts, material handling, transferring finished parts to post-processing, drilling, welding, painting, product inspection, picking and placing, die casting, glass making, grinding, etc.

In one embodiment, the data regarding the operations being performed by machines 104 is obtained from Internet of Things (IoT) sensors 106. IoT sensor 106, as used herein, refers to a sensor that can be attached to machine 104 located on the industrial floor. Furthermore, IoT sensors 106 are configured to exchange data with other devices and systems over a network, such as network 103. In one embodiment, IoT sensors 106 are configured to monitor machines 104 located at industrial facility 101. For example, IoT sensors 106 may monitor the operations of machines 104, such as loading and unloading parts, material handling, transferring finished parts to post-processing, drilling, welding, painting, product inspection, picking and placing, die casting, glass making, grinding, etc. In one embodiment, IoT sensors 106 capture the operational parameters (e.g., cutting speed, coolant temperature) of machines 104. Such data may then be captured by IoT sensors 106 and relayed to server 105 to be stored, such as in a storage device of server 105.

In one embodiment, the current location of machines 104 located on the industrial floor of industrial facility 101, including those machines 104 that are mobile, are determined based on location information (e.g., GPS (Global Positioning System) data) being provided to sensor 105 via the attached IoT sensors 106.

In one embodiment, such data is stored in log files. A “log” or “log file,” as used herein, refers to a computer-generated data file that contains information about usage patterns, activities, and operations, such as performed by machines 104. Log files show whether machines 104 are performing properly and optimally. In one embodiment, such log files indicate the operational parameters of machines 104 captured by IoT sensors 106 attached to such machines 104. In one embodiment, such log files are generated by machines 104 based on the data collected by IoT sensors 106 attached to such machines 104. In one embodiment, such log files are relayed to server 105 to be stored, such as in a storage device of server 105.

In one embodiment, such log files from machines 104 are obtained by unauthorized access detector 102, such as from server 105, via network 103 and stored in database 107 connected to unauthorized access detector 102.

In one embodiment, unauthorized access detector 102 is configured to detect unauthorized access of machines 104 in industrial facility 101. In one embodiment, unauthorized access detector 102 detects such unauthorized access via the use of a firewall 108 connected between network 103 and industrial facility 101. A firewall 108, as used herein, refers to a network security device that monitors traffic to or from a network, such as network 103. In one embodiment, firewall 108 allows or blocks traffic based on a defined set of security rules.

In one embodiment, firewall 108 generates logs (log files) each time that a firewall rule (security rule) applies to traffic. In one embodiment, such logging is referred to as “firewall rules logging,” which allows one to audit, verify, and analyze the effects of the firewall rules. In one embodiment, firewall rules logging is an option for any firewall rule, regardless of the action (allow or deny) or direction (ingress or egress) of the rule. In one embodiment, when logging for a firewall rule is enabled, an entry, referred to as a “connection record,” is created each time the rule allows or denies traffic. In one embodiment, each connection record contains the source and destination Internet Protocol (IP) addresses, the protocol and ports, date and time, and a reference to the firewall rule that applied to the traffic. The IP address, as used herein, refers to a unique address that identifies a device on the Internet or local network. Furthermore, each connection record includes actions performed by a user, such as a security hacker, in attempting to gain unauthorized access to machines 104, such as exploiting software vulnerabilities, social engineering tactics (e.g., phishing, smishing, spear phishing, ransomware, etc.), utilizing malware (malicious software) (e.g., viruses, worms, Trojan horses, ransomware, spyware, rogue software, etc.), etc. A “security hacker,” as used herein, refers to one or more individuals who focus on gaining unauthorized access to devices, such as machines 104. In one embodiment, such connection records are used to form the logs (log files).

In one embodiment, such log files from firewall 108 are analyzed by unauthorized access detector 102 to identify the behavior used in accessing or attempting to access one or more machines 104 located on the industrial floor of industrial facility 101. “Behavior,” as used herein, refers to the actions being performed, such as by a security hacker, in accessing or attempting to access one or more machines 104 located on the industrial floor of industrial facility 101. Such actions are obtained from the connection records of the log files from firewall 108 discussed above, including actions to gain unauthorized access to machines 104. Furthermore, in connection with such actions, the IP address of the device utilized to gain access to machines 104 is obtained from such connection records. In one embodiment, unauthorized access detector 102 analyzes the log files to identify the IP address of the device utilized by a user to access a machine 104 located on the industrial floor of industrial facility 101. In one embodiment, a comparison is made between the identified IP address of the device utilized by the user to access machine 104 with a list of known IP addresses of devices that are deemed to be trusted to have a secure communication with machines 104. In one embodiment, such a list of known IP addresses of devices that are deemed to be trusted to have a secure communication with machines 104 is stored in a data structure (e.g., table) that resides within database 107. In one embodiment, such a list of known IP addresses is populated by an expert. When the IP address of the device utilized by the user to access machine 104 does not match one of the IP addresses in the list of known IP addresses, then it may be inferred that a potential unauthorized access of machine 104 is being performed.

Furthermore, in one embodiment, unauthorized access detector 102 is configured to analyze a knowledge base (or “knowledge corpus”) 109 for unauthorized access tactics. A “knowledge base,” as used herein, refers to a collection of data that contains information pertaining to unauthorized access tactics that were previously used, such as by security hackers, to access machines 104 in an unauthorized manner. For example, such unauthorized access tactics include exploiting software vulnerabilities, social engineering tactics (e.g., phishing, smishing, spear phishing, ransomware, etc.), utilizing malware (malicious software) (e.g., viruses, worms, Trojan horses, ransomware, spyware, rogue software, etc.), etc. In one embodiment, such unauthorized access tactics include the pattern of attempting to acquire unauthorized access of a particular machine(s) 104 located on the industrial floor of industrial facility 101, which are identified via serial numbers. In one embodiment, such a knowledge base 109 is populated by an expert.

In one embodiment, unauthorized access detector 102 is configured to determine if the identified behavior (obtained from analyzing the log files from firewall 108) used in accessing or attempting to access one or more machines 104 is within a threshold degree of similarity to an unauthorized access tactic learned from knowledge base 109. A “threshold degree of similarity,” as used herein, refers to the identified behavior (obtained from analyzing the log files from firewall 108) having the same pattern as the unauthorized access tactic learned from knowledge base 109 within a threshold degree of similarity. In one embodiment, such a threshold degree is user-designated.

If the identified behavior (obtained from analyzing the log files from firewall 108) used in accessing or attempting to access one or more machines 104 is within a threshold degree of similarity to an unauthorized access tactic learned from knowledge base 109, then, in one embodiment, unauthorized access detector 102 is configured to analyze the log files from machines 104 located on the industrial floor of industrial facility 101 that were accessed or attempted to be access in an unauthorized manner to identify the operational parameters (e.g., cutting speed, coolant temperature) of such machines 104. As discussed above, in one embodiment, such log files are stored in database 107.

In one embodiment, unauthorized access detector 102 creates an augmented reality visualization to illustrate the unauthorized access tactic being performed on the machine(s) 104 located on the industrial floor of industrial facility 101 using the identified operational parameters of such machine(s) 104. “Augmented reality (AR),” as used herein, refers to superimposing a computer-generated image on a user's view of the real world, thus providing a composite view. In one embodiment, such an augmented reality visualization is displayed on augmented reality (AR) smart glasses 110 worn by a user 111, such as the machine operator of machine 104 located on the industrial floor of industrial facility 101. In one embodiment, augmented reality smart glasses 110 correspond to a headset that includes a display providing a graphical environment for virtual reality generation. The graphical environment includes graphical images and/or computer-generated perceptual information. The display of augmented reality glasses 110 encompasses part or all of a user's field of view.

Exemplary embodiments of a headset of augmented reality smart glasses 110 include a visor, a helmet, goggles, glasses, and other similar arrangements. Examples of augment reality glasses 110 can include, but are not limited to, Oculus Quest® 2, Microsoft® HoloLens® 2, Magic Leap One®, Google Glass® Enterprise Edition 2, etc.

In one embodiment, such an augmented reality visualization illustrates how machine(s) 104 are being accessed or attempted to be accessed in an unauthorized manner, such as via the use of avatars, which correspond to the security hacker and/or detected malware, which may be installed on machine 104.

In one embodiment, such an augmented reality visualization illustrates remedial actions to address the unauthorized access tactic. In one embodiment, such remedial actions are identified from knowledge base 109, which includes a listing of remedial actions to be performed (e.g., deactivate machine 104, lower cutting speed by 30%, etc.) based on various unauthorized access tactics being performed on various machines 104 located on the industrial floor of industrial facility 101. In one embodiment, such remedial actions are populated in knowledge base 109 by an expert.

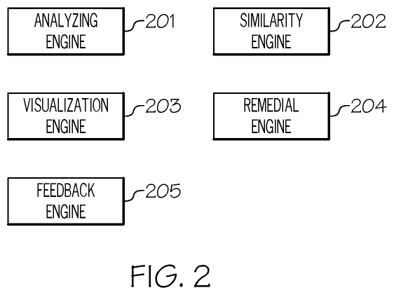

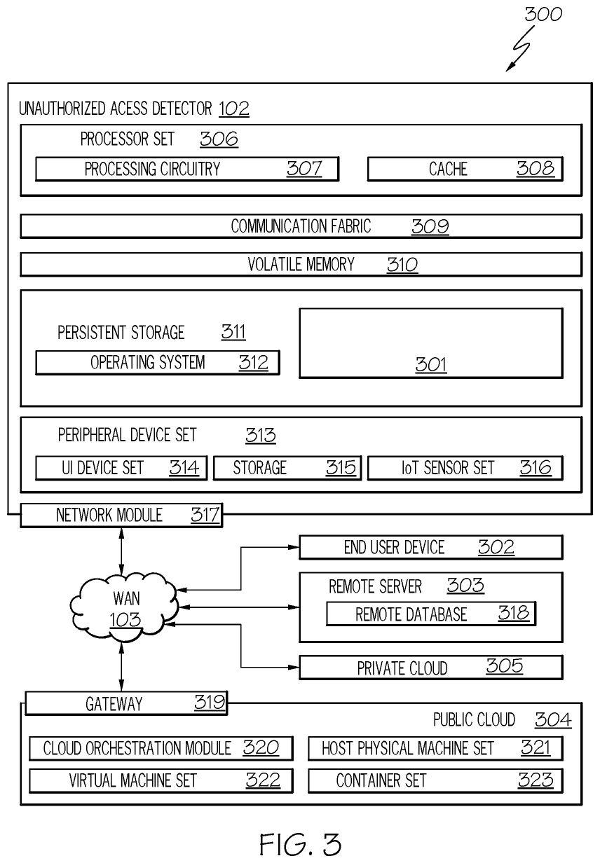

A description of the software components of unauthorized access detector 102 used for visualizing unauthorized access tactics to access or attempt to access machines 104 (e.g., robots, computer numerical control machine tools, automated guided vehicles) located on the industrial floor of industrial facility 101 is provided below in connection with FIG. 2. A description of the hardware configuration of unauthorized access detector 102 is provided further below in connection with FIG. 3.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of industrial facilities 101, unauthorized access detectors 102, networks 103, machines 104, servers 105, IoT sensors 106, databases 107, firewalls 108, knowledge bases 109, augmented reality (AR) glasses 110 and users 111 (e.g., machine operators).

A discussion regarding the software components used by unauthorized access detector 102 for visualizing unauthorized access tactics to access or attempt to access machines 104 (e.g., robots, computer numerical control machine tools, automated guided vehicles) located on the industrial floor of industrial facility 101 is provided below in connection with FIG. 2.

FIG. 2 is a diagram of the software components used by unauthorized access detector 102 for visualizing unauthorized access tactics to access or attempt to access machines 104 (e.g., robots, computer numerical control machine tools, automated guided vehicles) located on the industrial floor of industrial facility 101 in accordance with an embodiment of the present disclosure.

Referring to FIG. 2, in conjunction with FIG. 1, unauthorized access detector 102 includes analyzing engine 201 configured to capture and analyze log files from firewall 108 to identify the behavior used in accessing or attempting to access a machine(s) 104 located on the industrial floor of industrial facility 101.

In one embodiment, analyzing engine 201 captures the logs (log files) generated from firewall 108 via network 103.

As discussed above, firewall 108, as used herein, refers to a network security device that monitors traffic to or from a network, such as network 103. In one embodiment, firewall 108 allows or blocks traffic based on a defined set of security rules.

In one embodiment, firewall 108 generates logs (log files) each time that a firewall rule (security rule) applies to traffic. In one embodiment, such logging is referred to as “firewall rules logging,” which allows one to audit, verify, and analyze the effects of the firewall rules. In one embodiment, firewall rules logging is an option for any firewall rule, regardless of the action (allow or deny) or direction (ingress or egress) of the rule. In one embodiment, when logging for a firewall rule is enabled, an entry, referred to as a “connection record,” is created each time the rule allows or denies traffic. In one embodiment, each connection record contains the source and destination Internet Protocol (IP) addresses, the protocol and ports, date and time, and a reference to the firewall rule that applied to the traffic. The IP address, as used herein, refers to a unique address that identifies a device on the Internet or local network. Furthermore, each connection record includes actions performed by a user, such as a security hacker, in attempting to gain unauthorized access to machines 104, such as exploiting software vulnerabilities, social engineering tactics (e.g., phishing, smishing, spear phishing, ransomware, etc.), utilizing malware (malicious software) (e.g., viruses, worms, Trojan horses, ransomware, spyware, rogue software, etc.), etc. A “security hacker,” as used herein, refers to one or more individuals who focus on gaining unauthorized access to devices, such as machines 104. In one embodiment, such connection records are used to form the logs (log files).

In one embodiment, such log files from firewall 108 are analyzed by analyzing engine 201 to identify the behavior used in accessing or attempting to access one or more machines 104 located on the industrial floor of industrial facility 101. “Behavior,” as used herein, refers to the actions being performed, such as by a security hacker, in accessing or attempting to access one or more machines 104 located on the industrial floor of industrial facility 101. Such actions are obtained from the connection records of the log files from firewall 108 discussed above, including actions to gain unauthorized access to machines 104. Furthermore, in connection with such actions, the IP address of the device utilized to gain access to machines 104 is obtained from such connection records. In one embodiment, analyzing engine 201 analyzes the log files to identify the IP address of the device utilized by a user to access a machine 104 located on the industrial floor of industrial facility 101. In one embodiment, a comparison is made between the identified IP address of the device utilized by the user to access machine 104 with a list of known IP addresses of devices that are deemed to be trusted to have a secure communication with machines 104. In one embodiment, such a list of known IP addresses of devices that are deemed to be trusted to have a secure communication with machines 104 is stored in a data structure (e.g., table) that resides within database 107. In one embodiment, such a list of known IP addresses is populated by an expert. When the IP address of the device utilized by the user to access machine 104 does not match one of the IP addresses in the list of known IP addresses, then it may be inferred that a potential unauthorized access of machine 104 is being performed.

In one embodiment, analyzing engine 201 analyzes the log files generated by firewall 108 utilizing various software tools, which can include, but are not limited to, SolarWinds® Security Event Manager, Papertrail, ManageEngine EventLog Analyzer, Loggly®, Sematext Logs, Paessler® PRTG Network Monitor, Splunk, etc.

Furthermore, in one embodiment, analyzing engine 201 analyzes knowledge base (also referred to as a “knowledge corpus”) 109 for unauthorized access tactics. As discussed above, a “knowledge base 109,” as used herein, refers to a collection of data that contains information pertaining to unauthorized access tactics that were previously used, such as by security hackers, to access machines 104 in an unauthorized manner. In one embodiment, knowledge base 109 is populated by an expert. For example, such unauthorized access tactics include exploiting software vulnerabilities, social engineering tactics (e.g., phishing, smishing, spear phishing, ransomware, etc.), utilizing malware (malicious software) (e.g., viruses, worms, Trojan horses, ransomware, spyware, rogue software, etc.), etc. In one embodiment, such unauthorized access tactics include the pattern of attempting to acquire unauthorized access of a particular machine(s) 104 located on the industrial floor of industrial facility 101, which are identified via serial numbers. In one embodiment, such serial numbers are linked to a type of machine in a data structure (e.g., table) stored in a storage device of server 105, which is accessible by analyzing engine 201 of unauthorized access detector 102 via network 103. In one embodiment, such a data structure is populated by an expert.

In one embodiment, analyzing engine 201 analyzes knowledge base 109 for unauthorized access tactics utilizing various software tools, which can include, but are not limited to, ClickUp®, ProProfs® Knowledge Base, Freshdesk®, Confluence®, etc.

Unauthorized access detector 102 further includes similarity engine 202 configured to detect an unauthorized access or an attempted unauthorized access to one or more machines 104 located on the industrial floor of industrial facility 101 based on the identified behavior (behavior identified by analyzing engine 201 analyzing the log files from firewall 108) being associated with an unauthorized access tactic of knowledge base 109 within a threshold degree of similarity.

In one embodiment, similarity engine 202 is configured to determine if the identified behavior (obtained from analyzing the log files from firewall 108) used in accessing or attempting to access one or more machines 104 is within a threshold degree of similarity to an unauthorized access tactic learned from knowledge base 109. A “threshold degree of similarity,” as used herein, refers to the identified behavior (obtained from analyzing the log files from firewall 108) having the same pattern as the unauthorized access tactic learned from knowledge base 109 within a threshold degree of similarity. In one embodiment, such a threshold degree is user-designated.

For example, similarity engine 202 obtains the identified behavior used in accessing or attempting to access one or more machines 104 from analyzing engine 201, which may include the IP address of the device requesting to access machine(s) 104 as well as the actions performed from such a device, such as requesting to deploy a known malware (e.g., Fireball, Emotet) to a particular machine 104 (e.g., a laser cutting tool identified by serial number XYZ, where such a serial number is linked to the type of machine). Similarity engine 202 may then determine if such identified behavior (e.g., requesting to deploy Fireball to a particular machine 104, such as a laser cutting tool identified by serial number XYZ) matches an unauthorized access tactic of knowledge base 109 within a threshold degree of similarity. For instance, the unauthorized access tactic of knowledge base 109 of requesting to deploy Fireball on machine 104 corresponding to a laser cutting tool that is located on the industrial floor of industrial facility 101 is deemed to be within the threshold degree of similarity as the identified behavior since both patterns involve requesting to deploy the same malware on a machine 104, which both correspond to a laser cutting tool.

In one embodiment, similarity engine 202 utilizes pattern recognition software to determine if the identified behavior used in accessing or attempting to access one or more machines 104 is within a threshold degree of similarity, which may be user-designated, of an unauthorized access tactic learned from knowledge base 109. Examples of such pattern recognition software can include, but are not limited to, HanAra®, Data Veil®, etc.

In one embodiment, similarity engine 202 uses a machine learning algorithm to build and train a model (machine learning model) to determine if the identified behavior used in accessing or attempting to access one or more machines 104 is within a threshold degree of similarity of an unauthorized access tactic learned from knowledge base 109. In one embodiment, similarity engine 202 builds and trains such a model (machine learning model) to perform such a determination using a sample data set that includes behaviors that are deemed to be within a threshold degree of similarity of various unauthorized access tactics from knowledge base 109. In one embodiment, such a sample data set is compiled by an expert.

Furthermore, such a sample data set is referred to herein as the “training data,” which is used by the machine learning algorithm to make predictions or decisions as to whether a behavior identified from the log files, such as the log files from firewall 108, is within a threshold degree of similarity to an unauthorized access tactic of knowledge base 109. The algorithm iteratively makes predictions as to whether a behavior identified from the log files, such as the log files from firewall 108, is within a threshold degree of similarity to an unauthorized access tactic of knowledge base 109 until the predictions achieve the desired accuracy as determined by an expert. Examples of such learning algorithms include nearest neighbor, Naïve Bayes, decision trees, linear regression, support vector machines, and neural networks.

If the identified behavior (obtained from analyzing the log files from firewall 108) used in accessing or attempting to access one or more machines 104 is within a threshold degree of similarity to an unauthorized access tactic learned from knowledge base 109, then analyzing engine 201 analyzes the logs files from machines 104 located on the industrial floor of industrial facility 101 that were accessed or attempted to be access in an unauthorized manner to identify the operational parameters (e.g., cutting speed, coolant temperature, operational steps, interactions with other machines 104) of such machines 104. As discussed above, in one embodiment, such log files are stored in database 107. For example, in one embodiment, IoT sensors 106 capture the operational parameters (e.g., cutting speed, coolant temperature, operational steps, interactions with other machines 104) of machines 104. Such data may then be relayed to server 105 to be stored, such as in a storage device of server 105. In one embodiment, such log files are obtained by unauthorized access detector 102, such as from server 105, via network 103 and stored in database 107.

Based on analyzing such log files, analyzing engine 201 may determine if there is a change in operation, such as the cutting speed of the computer numerical control machine tool being dramatically increased or the coolant temperature being dramatically reduced. Such changes may be visually reflected, such as via an augmented reality visualization that is displayed on augmented reality gasses 110 worn by user 111, such as a machine operator.

In one embodiment, analyzing engine 201 analyzes the log files generated by machines 104 utilizing various software tools, which can include, but are not limited to, SolarWinds® Security Event Manager, Papertrail, ManageEngine EventLog Analyzer, Loggly®, Sematext Logs, Paessler® PRTG Network Monitor, Splunk, etc.

Unauthorized access detector 102 additionally includes visualization engine 203 configured to create an augmented reality visualization to illustrate the unauthorized access tactic being performed on one or more machines 104 located on the industrial floor of industrial facility 101 using the identified operational parameters of such machines 104.

As discussed above, “augmented reality (AR),” as used herein, refers to superimposing a computer-generated image on a user's view of the real world, thus providing a composite view. In one embodiment, such an augmented reality visualization is displayed on augmented reality (AR) smart glasses 110 worn by a user 111, such as the machine operator of a machine 104 located on the industrial floor of industrial facility 101. In one embodiment, augmented reality smart glasses 110 correspond to a headset that includes a display providing a graphical environment for virtual reality generation. The graphical environment includes graphical images and/or computer-generated perceptual information. The display of augmented reality glasses 110 encompasses part or all of a user's field of view.

Exemplary embodiments of a headset of augmented reality smart glasses 110 include a visor, a helmet, goggles, glasses, and other similar arrangements. Examples of augment reality glasses 110 can include, but are not limited to, Oculus Quest® 2, Microsoft® HoloLens® 2, Magic Leap One®, Google Glass® Enterprise Edition 2, etc.

As discussed above, in one embodiment, an augmented reality visualization is created to illustrate the unauthorized access tactic being performed on one or more machines 104 located on the industrial floor of industrial facility 101 using the identified operational parameters of such machines 104. For example, based on such operational parameters, the augmented reality visualization may include a visualization of operational parameters, such as coolant temperature, cutting speed, etc. Furthermore, such operational parameters may be used by visualization engine 203 for visually depicting using augmented reality the operational steps of machine 104 (e.g., drilling, grinding, etc.) as well as the interactions with other machines 104 (e.g., robot handlers placing panels at a precise location so that the welding robot can perform all the programmed welds).

In one embodiment, visualization engine 203 creates avatars of the security hacker and/or the detected unauthorized access tactic, such as malware, which may be installed on machine 104. An “avatar,” as used herein, refers to a graphical representation of a user or object. A “security hacker,” as used herein, refers to one or more individuals who focus on gaining unauthorized access to devices, such as machines 104.

In one embodiment, visualization engine 203 illustrates the unauthorized access being performed on one or more machines 104 located on the industrial floor of industrial facility 101 in the augmented reality visualization using the created avatars. For example, avatars of the security hacker along with the unauthorized access tactic (e.g., utilizing malware) may be displayed in the augmented reality visualization.

In one embodiment, visualization engine 203 creates such an augmented reality visualization using various software tools, which can include, but are not limited to, Sketchfab®, Aryel®, SketchAR®, Threekit®, Zapworks®, etc.

Unauthorized access detector 102 further includes a remedial engine 204 configured to identify a remedial action to address the unauthorized access tactic using knowledge base 109. In one embodiment, such remedial actions are identified from knowledge base 109, which includes a listing of remedial actions to be performed (e.g., deactivate machine 104, lower cutting speed by 30%, etc.) to address the unauthorized access tactics specified in knowledge base 109. In one embodiment, such remedial actions are populated in knowledge base 109 by an expert.

For example, in one embodiment, upon similarity engine 202 identifying an unauthorized access tactic in knowledge base 109 that is within a threshold degree of similarity to the identified behavior used in accessing or attempting to access a machine(s) 104 located on the industrial floor of industrial facility 101, remedial engine 204 then searches knowledge base 109 for any remedial actions to address such an unauthorized access tactic. In one embodiment, remedial engine 204 uses various software tools to identify such a remedial action, which can include, but are not limited to, ClickUp®, ProProfs® Knowledge Base, Freshdesk®, Confluence®, etc.

Furthermore, in one embodiment, visualization engine 203 is configured to illustrate the identified remedial action to address the unauthorized access tactic in the augmented reality visualization. For example, in one embodiment, visualization engine 203 illustrates how the identified remedial action (e.g., reduce cutting speed of machine 104 by 30%, deactivate machine 104) is performed to address the unauthorized access tactic in the augmented reality visualization. In one embodiment, visualization engine 203 illustrates the remedial action addressing the unauthorized access tactic in the augmented reality visualization using various software tools, which can include, but are not limited to, Sketchfab®, Aryel®, SketchAR®, Threekit®, Zapworks®, etc.

Additionally, unauthorized access detector 102 includes a feedback engine 205 configured to update knowledge base 109 based on the feedback received from a user, such as user 111, regarding the augmented reality visualization. For example, if the remedial action did not fully address the unauthorized access tactic by lowering the cutting speed of machine 104 by 30%, but instead, the cutting speed of machine 104 had to be lowered by 50% in order to address the unauthorized access tactic, then such information will be used to update knowledge base 109. As a result, in the future, when such an unauthorized access tactic is identified, the more appropriate remedial action of recommending to lower the cutting speed of machine 104 by 50% will be recommended.

In one embodiment, feedback may be provided by the user in various manners, such as via the graphical user interface of unauthorized access detector 102. In one embodiment, feedback is provided by the user (e.g., user 111) via electronic means, such as via electronic mail and text messaging.

Feedback engine 205 is configured to update knowledge base 109 with the received feedback using various software tools, which can include, but are not limited to, ClickUp®, ProProfs® Knowledge Base, Freshdesk®, Confluence®, etc.

A further description of these and other features is provided below in connection with the discussion of the method for visualizing unauthorized access or attempted unauthorized access of machines 104 located on the industrial floor of industrial facility 101.

Prior to the discussion of the method for visualizing unauthorized access or attempted unauthorized access of machines 104 located on the industrial floor of industrial facility 101, a description of the hardware configuration of unauthorized access detector 102 (FIG. 1) is provided below in connection with FIG. 3.

Referring now to FIG. 3, in conjunction with FIG. 1, FIG. 3 illustrates an embodiment of the present disclosure of the hardware configuration of unauthorized access detector 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (computer code for visualizing unauthorized access or attempted unauthorized access of machines 104 located on the industrial floor of industrial facility 101, which is stored in block 301) involved in performing the disclosed methods, such as visualizing unauthorized access or attempted unauthorized access of machines 104 located on the industrial floor of industrial facility 101. In addition to block 301, computing environment 300 includes, for example, unauthorized access detector 102, network 103, such as a wide area network (WAN), end user device (EUD) 302, remote server 303, public cloud 304, and private cloud 305. In this embodiment, unauthorized access detector 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Unauthorized access detector 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically unauthorized access detector 102, to keep the presentation as simple as possible. Unauthorized access detector 102 may be located in a cloud, even though it is not shown in a cloud in FIG. 3. On the other hand, unauthorized access detector 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto unauthorized access detector 102 to cause a series of operational steps to be performed by processor set 306 of unauthorized access detector 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 308 and the other storage media discussed below. The program instructions, and associated data, are accessed by processor set 306 to control and direct performance of the disclosed methods. In computing environment 300, at least some of the instructions for performing the disclosed methods may be stored in block 301 in persistent storage 311.

Communication fabric 309 is the signal conduction paths that allow the various components of unauthorized access detector 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In unauthorized access detector 102, the volatile memory 310 is located in a single package and is internal to unauthorized access detector 102, but, alternatively or additionally, the volatile memory may be distributed over multiple packages and/or located externally with respect to unauthorized access detector 102.

Persistent Storage 311 is any form of non-volatile storage for computers that is now known or to be developed in the future. The non-volatility of this storage means that the stored data is maintained regardless of whether power is being supplied to unauthorized access detector 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the disclosed methods.

Peripheral device set 313 includes the set of peripheral devices of unauthorized access detector 102. Data communication connections between the peripheral devices and the other components of unauthorized access detector 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where unauthorized access detector 102 is required to have a large amount of storage (for example, where unauthorized access detector 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows unauthorized access detector 102 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the disclosed methods can typically be downloaded to unauthorized access detector 102 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates unauthorized access detector 102), and may take any of the forms discussed above in connection with unauthorized access detector 102. EUD 302 typically receives helpful and useful data from the operations of unauthorized access detector 102. For example, in a hypothetical case where unauthorized access detector 102 is designed to provide a recommendation to an end user, this recommendation would typically be communicated from network module 317 of unauthorized access detector 102 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to unauthorized access detector 102. Remote server 303 may be controlled and used by the same entity that operates unauthorized access detector 102. Remote server 303 represents the machine(s) that collect and store helpful and useful data for use by other computers, such as unauthorized access detector 102. For example, in a hypothetical case where unauthorized access detector 102 is designed and programmed to provide a recommendation based on historical data, then this historical data may be provided to unauthorized access detector 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to visualize unauthorized access or attempted unauthorized access of machines 104 located on the industrial floor of industrial facility 101. In one embodiment, such components may be implemented in hardware. The functions discussed above performed by such components are not generic computer functions. As a result, unauthorized access detector 102 is a particular machine that is the result of implementing specific, non-generic computer functions.

In one embodiment, the functionality of such software components of unauthorized access detector 102, including the functionality for visualizing unauthorized access or attempted unauthorized access of machines 104 located on the industrial floor of industrial facility 101, may be embodied in an application specific integrated circuit.

As stated above, in the context of the manufacturing industry, various machines (e.g., robots, computer numerical control machine tools, automated guided vehicles, etc.) located on the industrial floor (floor, such as concrete, used in industrial and commercial settings) are used to manufacture and produce parts, goods, pieces, etc., such as in a plant, factory, etc. For example, such machines may correspond to robots that weld and assemble parts. In another example, computer numerical control machines cut metal pieces to precise specification. In a further example, engine machining stations are used to create engine blocks. Users (referred to as “security hackers”) may attempt to gain unauthorized access to such machines located on the industrial floor to steal sensitive data, cause damage, hold data hostage as part of a ransomware attack, play a prank, etc. For example, a security hacker may attempt to gain unauthorized access to a computer numerical control machine tool to manipulate the machine's programming to cause it to create defective parts. If the machine's operator does not notice the problem in time, then those defective parts will enter the market. In another example, a security hacker may attempt to gain unauthorized access to a computer numerical control machine tool to gain a competitive advantage by stealing confidential, proprietary information. There are various means for a security hacker to attempt to gain unauthorized access to machines located on the industrial floor, such as exploiting software vulnerabilities. Other means include social engineering tactics, such as phishing, smishing, spear phishing, ransomware, etc. Furthermore, security hackers may utilize malware (malicious software) to gain unauthorized access to the machines located on the industrial floor, including information stored on such machines. Malware is software intentionally designed to gain unauthorized access to information or systems, such as machines located on the industrial floor. Examples of such malware include computer viruses, worms, Trojan horses, ransomware, spyware, rogue software, etc. Unfortunately, there is not currently a means for effectively informing the machine operators, such as visually, of such attempts to gain unauthorized access to the machines located on the industrial floor. Such machine operators need to have knowledge of which machines on the industrial floor are being attempted to be accessed without permission or have actually been accessed without permission in order for the machine operators to take remedial action to address such attempted or successful unauthorized access of the machines located on the industrial floor.

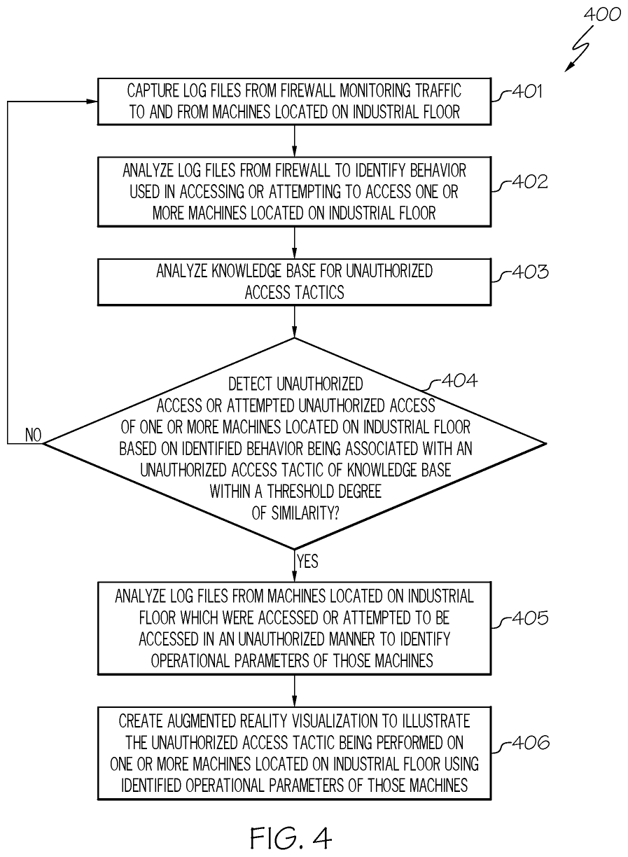

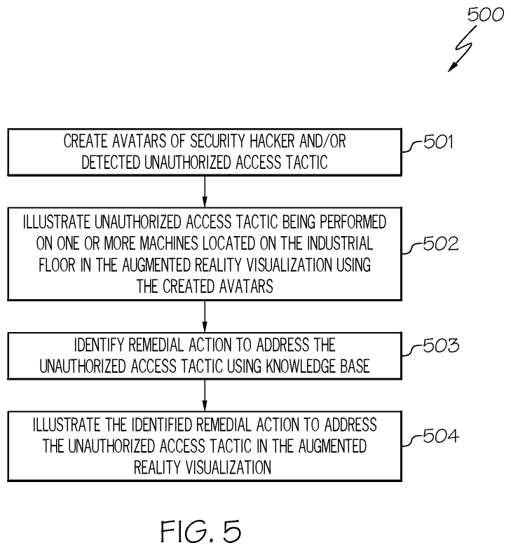

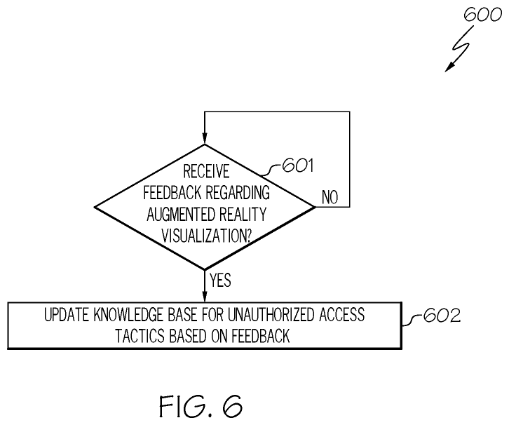

The embodiments of the present disclosure provide a means for effectively informing the machine operators of attempts to gain unauthorized access to the machines located on the industrial floor by illustrating unauthorized access tactics being performed on the machines located on the industrial floor using an augmented reality visualization as discussed below in connection with FIGS. 4-6. FIG. 4 is a flowchart of a method for visualizing unauthorized access or attempted unauthorized access of machines 104 located on the industrial floor of industrial facility 101. FIG. 5 is a flowchart of a method for creating an augmented reality visualization. FIG. 6 is a flowchart of a method for updating the knowledge base with received feedback regarding the augmented reality visualization.

As stated above, FIG. 4 is a flowchart of a method 400 for visualizing unauthorized access or attempted unauthorized access of machines 104 located on the industrial floor of industrial facility 101 in accordance with an embodiment of the present disclosure.

Referring to FIG. 4, in conjunction with FIGS. 1-3, in operation 401, analyzing engine 201 of unauthorized access detector 102 captures the log files from firewall 108 monitoring traffic to and from machines 104 located on the industrial floor of industrial facility 101.

As discussed above, in one embodiment, analyzing engine 201 captures the log files generated from firewall 108 via network 103.

Furthermore, as discussed above, firewall 108, as used herein, refers to a network security device that monitors traffic to or from a network, such as network 103. In one embodiment, firewall 108 allows or blocks traffic based on a defined set of security rules.

In one embodiment, firewall 108 generates log files each time that a firewall rule (security rule) applies to traffic. In one embodiment, such logging is referred to as “firewall rules logging,” which allows one to audit, verify, and analyze the effects of the firewall rules. In one embodiment, firewall rules logging is an option for any firewall rule, regardless of the action (allow or deny) or direction (ingress or egress) of the rule. In one embodiment, when logging for a firewall rule is enabled, an entry, referred to as a “connection record,” is created each time the rule allows or denies traffic. In one embodiment, each connection record contains the source and destination Internet Protocol (IP) addresses, the protocol and ports, date and time, and a reference to the firewall rule that applied to the traffic. The IP address, as used herein, refers to a unique address that identifies a device on the Internet or local network. Furthermore, each connection record includes actions performed by a user, such as a security hacker, in attempting to gain unauthorized access to machines 104, such as exploiting software vulnerabilities, social engineering tactics (e.g., phishing, smishing, spear phishing, ransomware, etc.), utilizing malware (malicious software) (e.g., viruses, worms, Trojan horses, ransomware, spyware, rogue software, etc.), etc. A “security hacker,” as used herein, refers to one or more individuals who focus on gaining unauthorized access to devices, such as machines 104. In one embodiment, such connection records are used to form the log files.

In operation 402, analyzing engine 201 of unauthorized access detector 102 analyzes the captured log files from firewall 108 to identify the behavior used in accessing or attempting to access one or more machines 104 located on the industrial floor of industrial facility 101.

As stated above, “behavior,” as used herein, refers to the actions being performed, such as by a security hacker, in accessing or attempting to access one or more machines 104 located on the industrial floor of industrial facility 101. Such actions are obtained from the connection records of the log files from firewall 108 discussed above, including actions to gain unauthorized access to machines 104. Furthermore, in connection with such actions, the IP address of the device utilized to gain access to machines 104 is obtained from such connection records. In one embodiment, analyzing engine 201 analyzes the log files to identify the IP address of the device utilized by a user to access a machine 104 located on the industrial floor of industrial facility 101. In one embodiment, a comparison is made between the identified IP address of the device utilized by the user to access machine 104 with a list of known IP addresses of devices that are deemed to be trusted to have a secure communication with machines 104. In one embodiment, such a list of known IP addresses of devices that are deemed to be trusted to have a secure communication with machines 104 is stored in a data structure (e.g., table) that resides within database 107. In one embodiment, such a list of known IP addresses is populated by an expert. When the IP address of the device utilized by the user to access machine 104 does not match one of the IP addresses in the list of known IP addresses, then it may be inferred that a potential unauthorized access of machine 104 is being performed.

In one embodiment, analyzing engine 201 analyzes the log files generated by firewall 108 utilizing various software tools, which can include, but are not limited to, SolarWinds® Security Event Manager, Papertrail, ManageEngine EventLog Analyzer, Loggly®, Sematext Logs, Paessler® PRTG Network Monitor, Splunk, etc.

In operation 403, analyzing engine 201 of unauthorized access detector 102 analyzes knowledge base 109 for unauthorized access tactics.

As discussed above, a “knowledge base 109,” as used herein, refers to a collection of data that contains information pertaining to unauthorized access tactics that were previously used, such as by security hackers, to access machines 104 in an unauthorized manner. In one embodiment, knowledge base 109 is populated by an expert. For example, such unauthorized access tactics include exploiting software vulnerabilities, social engineering tactics (e.g., phishing, smishing, spear phishing, ransomware, etc.), utilizing malware (malicious software) (e.g., viruses, worms, Trojan horses, ransomware, spyware, rogue software, etc.), etc. In one embodiment, such unauthorized access tactics include the pattern of attempting to acquire unauthorized access of a particular machine(s) 104 located on the industrial floor of industrial facility 101, which are identified via serial numbers. In one embodiment, such serial numbers are linked to a type of machine in a data structure (e.g., table) stored in a storage device of server 105, which is accessible by analyzing engine 201 of unauthorized access detector 102 via network 103. In one embodiment, such a data structure is populated by an expert.

In one embodiment, analyzing engine 201 analyzes knowledge base 109 for unauthorized access tactics utilizing various software tools, which can include, but are not limited to, ClickUp®, ProProfs® Knowledge Base, Freshdesk®, Confluence®, etc.

In operation 404, similarity engine 202 of unauthorized access detector 102 determines whether an unauthorized access or attempted unauthorized access of one or more machines 104 located on the industrial floor of industrial facility 101 is detected based on the identified behavior (identified in operation 402) being associated with an unauthorized access tactic of knowledge base 109 within a threshold degree of similarity.

As discussed above, in one embodiment, similarity engine 202 is configured to determine if the identified behavior (obtained from analyzing the log files from firewall 108) used in accessing or attempting to access one or more machines 104 is within a threshold degree of similarity to an unauthorized access tactic learned from knowledge base 109. A “threshold degree of similarity,” as used herein, refers to the identified behavior (obtained from analyzing the log files from firewall 108) having the same pattern as the unauthorized access tactic learned from knowledge base 109 within a threshold degree of similarity. In one embodiment, such a threshold degree is user-designated.

For example, similarity engine 202 obtains the identified behavior used in accessing or attempting to access one or more machines 104 from analyzing engine 201, which may include the IP address of the device requesting to access machine(s) 104 as well as the actions performed from such a device, such as requesting to deploy a known malware (e.g., Fireball, Emotet) to a particular machine 104 (e.g., a laser cutting tool identified by serial number XYZ, where such a serial number is linked to the type of machine). Similarity engine 202 may then determine if such identified behavior (e.g., requesting to deploy Fireball to a particular machine 104, such as a laser cutting tool identified by serial number XYZ) matches an unauthorized access tactic of knowledge base 109 within a threshold degree of similarity. For instance, the unauthorized access tactic of knowledge base 109 of requesting to deploy Fireball on machine 104 corresponding to a laser cutting tool that is located on the industrial floor of industrial facility 101 is deemed to be within the threshold degree of similarity as the identified behavior since both patterns involve requesting to deploy the same malware on a machine 104, which both correspond to a laser cutting tool.

In one embodiment, similarity engine 202 utilizes pattern recognition software to determine if the identified behavior used in accessing or attempting to access one or more machines 104 is within a threshold degree of similarity, which may be user-designated, of an unauthorized access tactic learned from knowledge base 109. Examples of such pattern recognition software can include, but are not limited to, HanAra®, Data Veil®, etc.

In one embodiment, similarity engine 202 uses a machine learning algorithm to build and train a model (machine learning model) to determine if the identified behavior used in accessing or attempting to access one or more machines 104 is within a threshold degree of similarity of an unauthorized access tactic learned from knowledge base 109. In one embodiment, similarity engine 202 builds and trains such a model (machine learning model) to perform such a determination using a sample data set that includes behaviors that are deemed to be within a threshold degree of similarity of various unauthorized access tactics from knowledge base 109. In one embodiment, such a sample data set is compiled by an expert.

Furthermore, such a sample data set is referred to herein as the “training data,” which is used by the machine learning algorithm to make predictions or decisions as to whether a behavior identified from the log files, such as the log files from firewall 108, is within a threshold degree of similarity to an unauthorized access tactic of knowledge base 109. The algorithm iteratively makes predictions as to whether a behavior identified from the log files, such as the log files from firewall 108, is within a threshold degree of similarity to an unauthorized access tactic of knowledge base 109 until the predictions achieve the desired accuracy as determined by an expert. Examples of such learning algorithms include nearest neighbor, Naïve Bayes, decision trees, linear regression, support vector machines, and neural networks.

If the identified behavior (obtained from analyzing the log files from firewall 108) used in accessing or attempting to access one or more machines 104 is not within a threshold degree of similarity to an unauthorized access tactic learned from knowledge base 109, then analyzing engine 201 continues to capture the log files generated from firewall 108 via network 103 in operation 401.

If, however, the identified behavior (obtained from analyzing the log files from firewall 108) used in accessing or attempting to access one or more machines 104 is within a threshold degree of similarity to an unauthorized access tactic learned from knowledge base 109, then, in operation 405, analyzing engine 201 of unauthorized access detector 102 analyzes the log files from machines 104 located on the industrial floor of industrial facility 101 that were accessed or attempted to be access in an unauthorized manner to identify the operational parameters (e.g., cutting speed, coolant temperature, operational steps, interactions with other machines 104) of such machines 104.

As discussed above, in one embodiment, such log files are stored in database 107. For example, in one embodiment, IoT sensors 106 capture the operational parameters (e.g., cutting speed, coolant temperature, operational steps, interactions with other machines 104) of machines 104. Such data may then be captured by IoT sensors 106 and relayed to server 105 to be stored, such as in a storage device of server 105. In one embodiment, such log files are obtained by unauthorized access detector 102, such as from server 105, via network 103 and stored in database 107.

Based on analyzing such log files, analyzing engine 201 may determine if there is a change in operation, such as the cutting speed of the computer numerical control machine tool being dramatically increased or the coolant temperature being dramatically reduced. Such changes may be visually reflected, such as via an augmented reality visualization that is displayed on augmented reality gasses 110 worn by user 111, such as a machine operator.

In one embodiment, analyzing engine 201 analyzes the log files generated by machines 104 utilizing various software tools, which can include, but are not limited to, SolarWinds® Security Event Manager, Papertrail, ManageEngine EventLog Analyzer, Loggly®, Sematext Logs, Paessler® PRTG Network Monitor, Splunk, etc.

In operation 406, visualization engine 203 of unauthorized access detector 102 creates an augmented reality visualization to illustrate the unauthorized access tactic being performed on one or more machines 104 located on the industrial floor of industrial facility 101 using the identified operational parameters of such machines 104.

As discussed above, “augmented reality (AR),” as used herein, refers to superimposing a computer-generated image on a user's view of the real world, thus providing a composite view. In one embodiment, such an augmented reality visualization is displayed on augmented reality (AR) smart glasses 110 worn by a user 111, such as the machine operator of a machine 104 located on the industrial floor of industrial facility 101. In one embodiment, augmented reality smart glasses 110 correspond to a headset that includes a display providing a graphical environment for virtual reality generation. The graphical environment includes graphical images and/or computer-generated perceptual information. The display of augmented reality glasses 110 encompasses part or all of a user's field of view.

Exemplary embodiments of a headset of augmented reality smart glasses 110 include a visor, a helmet, goggles, glasses, and other similar arrangements. Examples of augment reality glasses 110 can include, but are not limited to, Oculus Quest® 2, Microsoft® HoloLens® 2, Magic Leap One®, Google Glass® Enterprise Edition 2, etc.

As discussed above, in one embodiment, an augmented reality visualization is created to illustrate the unauthorized access tactic being performed on one or more machines 104 located on the industrial floor of industrial facility 101 using the identified operational parameters of such machines 104. For example, based on such operational parameters, the augmented reality visualization may include a visualization of operational parameters, such as coolant temperature, cutting speed, etc. Furthermore, such operational parameters may be used by visualization engine 203 for visually depicting using augmented reality the operational steps of machine 104 (e.g., drilling, grinding, etc.) as well as the interactions with other machines 104 (e.g., robot handlers placing panels at a precise location so that the welding robot can perform all the programmed welds).

A further discussion regarding creating such an augmented reality visualization is provided below in connection with FIG. 5.

FIG. 5 is a flowchart of a method 500 for creating an augmented reality visualization in accordance with an embodiment of the present disclosure.

Referring to FIG. 5, in conjunction with FIGS. 1-4, in operation 501, visualization engine 203 of unauthorized access detector 102 creates avatars of the security hacker and/or the detected unauthorized access tactic, such as malware, which may be installed on machine 104. An “avatar,” as used herein, refers to a graphical representation of a user or object. A “security hacker,” as used herein, refers to one or more individuals who focus on gaining unauthorized access to devices, such as machines 104.

In operation 502, visualization engine 203 of unauthorized access detector 102 illustrates the unauthorized access being performed on one or more machines 104 located on the industrial floor of industrial facility 101 in the augmented reality visualization using the created avatars. For example, avatars of the security hacker along with the unauthorized access tactic (e.g., malware) may be displayed in the augmented reality visualization.

As stated above, in one embodiment, visualization engine 203 creates such an augmented reality visualization using various software tools, which can include, but are not limited to, Sketchfab®, Aryel®, SketchAR®, Threekit®, Zapworks®, etc.

In operation 503, remedial engine 204 of unauthorized access detector 102 identifies a remedial action to address the unauthorized access tactic using knowledge base 109.

As discussed above, in one embodiment, such remedial actions are identified from knowledge base 109, which includes a listing of remedial actions to be performed (e.g., deactivate machine 104, lower cutting speed by 30%, etc.) to address the unauthorized access tactics specified in knowledge base 109. In one embodiment, such remedial actions are populated in knowledge base 109 by an expert.

For example, in one embodiment, upon similarity engine 202 identifying an unauthorized access tactic in knowledge base 109 that is within a threshold degree of similarity to the identified behavior used in accessing or attempting to access a machine(s) 104 located on the industrial floor of industrial facility 101, remedial engine 204 then searches knowledge base 109 for any remedial actions to address such an unauthorized access tactic. In one embodiment, remedial engine 204 uses various software tools to identify such a remedial action, which can include, but are not limited to, ClickUp®, ProProfs® Knowledge Base, Freshdesk®, Confluence®, etc.

In operation 504, visualization engine 203 of unauthorized access detector 102 illustrates the identified remedial action to address the unauthorized access tactic in the augmented reality visualization.

For example, in one embodiment, visualization engine 203 illustrates how the identified remedial action (e.g., reduce cutting speed of machine 104 by 30%, deactivate machine 104) is performed to address the unauthorized access tactic in the augmented reality visualization. In one embodiment, visualization engine 203 illustrates the remedial action addressing the unauthorized access tactic in the augmented reality visualization using various software tools, which can include, but are not limited to, Sketchfab®, Aryel®, SketchAR®, Threekit®, Zapworks®, etc.

Furthermore, feedback, such as from the machine operators (e.g., user 111), may be provided concerning the accuracy of the augmented reality visualization. Such feedback may be used to update knowledge base 109 to improve the accuracy of unauthorized access tactics stored in knowledge base 109, such as those tactics used by security hackers, and/or the remedial actions to address the unauthorized access tactics. A discussion regarding updating knowledge base 109 based on such feedback is provided below in connection with FIG. 6.

FIG. 6 is a flowchart of a method 600 for updating knowledge base 109 with received feedback regarding the augmented reality visualization in accordance with an embodiment of the present disclosure.

Referring to FIG. 6, in conjunction with FIGS. 1-5, in operation 601, feedback engine 205 of unauthorized access detector 102 determines whether feedback is received, such as from user 111 (e.g., machine operator), regarding the augmented reality visualization, such as the augmented reality visualization that is displayed on augmented reality glasses 110.

If feedback engine 205 does not receive such feedback, feedback engine 205 of unauthorized access detector 102 continues to determine whether feedback is received, such as from user 111 (e.g., machine operator), regarding the augmented reality visualization, such as the augmented reality visualization that is displayed on augmented reality glasses 110, in operation 601.

If, however, feedback is received, such as from user 111 (e.g., machine operator), regarding the augmented reality visualization, such as the augmented reality visualization that is displayed on augmented reality glasses 110, then, in operation 602, feedback engine 205 of unauthorized access detector 102 updates knowledge base 109 based on the feedback received from the user (e.g., user 111) regarding the augmented reality visualization.

In one embodiment, feedback may be provided by the user in various manners, such as via the graphical user interface of unauthorized access detector 102. In one embodiment, feedback is provided by the user (e.g., user 111) via electronic means, such as via electronic mail and text messaging.

For example, if the remedial action did not fully address the unauthorized access tactic by lowering the cutting speed of machine 104 by 30%, but instead, the cutting speed of machine 104 had to be lowered by 50% in order to address the unauthorized access tactic, then such information will be used to update knowledge base 109. As a result, in the future, when such an unauthorized access tactic is identified, the more appropriate remedial action of recommending to lower the cutting speed of machine 104 by 50% will be recommended.

Feedback engine 205 is configured to update knowledge base 109 with the received feedback using various software tools, which can include, but are not limited to, ClickUp®, ProProfs® Knowledge Base, Freshdesk®, Confluence®, etc.

In this manner, machine operators will now be effectively informed of attempts to gain unauthorized access to the machines located on the industrial floor. For example, such machine operators will now be able to visualize such unauthorized access or attempted unauthorized access of the machines located on the industrial floor, such as via an augmented reality visualization that is displayed on the augmented reality glasses worn by the machine operator. Furthermore, such an augmented reality visualization may include a possible remedial action to perform in order to address the unauthorized access or attempted unauthorized access of the machine(s) located on the industrial floor. As a result of the foregoing, machine operators will now have knowledge of the machines on the industrial floor that are being attempted to be accessed without permission or have actually been accessed without permission thereby allowing the machine operators to take remedial action to address such attempted or successful unauthorized access of the machine(s).

Furthermore, the principles of the present disclosure improve the technology or technical field involving unauthorized access. As discussed above, in the context of the manufacturing industry, various machines (e.g., robots, computer numerical control machine tools, automated guided vehicles, etc.) located on the industrial floor (floor, such as concrete, used in industrial and commercial settings) are used to manufacture and produce parts, goods, pieces, etc., such as in a plant, factory, etc. For example, such machines may correspond to robots that weld and assemble parts. In another example, computer numerical control machines cut metal pieces to precise specification. In a further example, engine machining stations are used to create engine blocks. Users (referred to as “security hackers”) may attempt to gain unauthorized access to such machines located on the industrial floor to steal sensitive data, cause damage, hold data hostage as part of a ransomware attack, play a prank, etc. For example, a security hacker may attempt to gain unauthorized access to a computer numerical control machine tool to manipulate the machine's programming to cause it to create defective parts. If the machine's operator does not notice the problem in time, then those defective parts will enter the market. In another example, a security hacker may attempt to gain unauthorized access to a computer numerical control machine tool to gain a competitive advantage by stealing confidential, proprietary information. There are various means for a security hacker to attempt to gain unauthorized access to machines located on the industrial floor, such as exploiting software vulnerabilities. Other means include social engineering tactics, such as phishing, smishing, spear phishing, ransomware, etc. Furthermore, security hackers may utilize malware (malicious software) to gain unauthorized access to the machines located on the industrial floor, including information stored on such machines. Malware is software intentionally designed to gain unauthorized access to information or systems, such as machines located on the industrial floor. Examples of such malware include computer viruses, worms, Trojan horses, ransomware, spyware, rogue software, etc. Unfortunately, there is not currently a means for effectively informing the machine operators, such as visually, of such attempts to gain unauthorized access to the machines located on the industrial floor. Such machine operators need to have knowledge of which machines on the industrial floor are being attempted to be accessed without permission or have actually been accessed without permission in order for the machine operators to take remedial action to address such attempted or successful unauthorized access of the machines located on the industrial floor.

Embodiments of the present disclosure improve such technology by capturing log files from the firewall monitoring traffic to and from the machines located on the industrial floor of the industrial facility. The captured log files are then analyzed to identify the behavior used in accessing or attempting to access one or more machines located on the industrial floor of the industrial facility. “Behavior,” as used herein, refers to the actions being performed, such as by a security hacker, in accessing or attempting to access the machine(s) located on the industrial floor of the industrial facility. Furthermore, a knowledge base for unauthorized access tactics is analyzed. A “knowledge base,” as used herein, refers to a collection of data that contains information pertaining to unauthorized access tactics that were previously used, such as by security hackers, to access the machine(s) located on the industrial floor of the industrial facility in an unauthorized manner. An augmented reality visualization may then be created to illustrate the unauthorized access tactic being performed on the machine(s) located on the industrial floor of the industrial facility if the identified behavior is within a threshold degree of similarity to the unauthorized access tactic learned from the knowledge base. In this manner, machine operators will now be effectively informed of attempts to gain unauthorized access to the machines located on the industrial floor, such as via the augmented reality visualization. As a result, machine operators will now have knowledge of the machines on the industrial floor that are being attempted to be accessed without permission or have actually been accessed without permission thereby allowing the machine operators to take remedial action to address such attempted or successful unauthorized access of the machine(s). Furthermore, in this manner, there is an improvement in the technical field involving unauthorized access.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for visualizing unauthorized access or attempted unauthorized access of machines located on an industrial floor, the method comprising: capturing log files from a firewall monitoring traffic to and from the machines located on the industrial floor;
analyzing the log files from the firewall to identify a behavior used in accessing or attempting to access one or more machines of the machines located on the industrial floor;
analyzing a knowledge base for unauthorized access tactics; and
creating an augmented reality visualization to illustrate an unauthorized access tactic being performed on the one or more machines located on the industrial floor in response to the identified behavior being associated with the unauthorized access tactic within a threshold degree of similarity based on the analysis of the knowledge base.

2. The method as recited in claim 1 further comprising:
analyzing log files from the one or more machines located on the industrial floor to identify operational parameters.

3. The method as recited in claim 2 further comprising:
creating the augmented reality visualization to illustrate the unauthorized access tactic being performed on the one or more machines located on the industrial floor using the identified operational parameters.

4. The method as recited in claim 1 further comprising:
creating one or more avatars of a security hacker and/or a detected malware; and
illustrating the unauthorized access tactic being performed on the one or more machines located on the industrial floor in the augmented reality visualization using the created one or more avatars.

5. The method as recited in claim 4 further comprising:
identifying a remedial action to address the unauthorized access tactic being performed on the one or more machines located on the industrial floor using the knowledge base; and
illustrating the identified remedial action to address the unauthorized access tactic being performed on the one or more machines in the augmented reality visualization.

6. The method as recited in claim 1 further comprising:
receiving feedback regarding the augmented reality visualization; and
updating the knowledge base for unauthorized access tactics based on the feedback.

7. The method as recited in claim 1, wherein the augmented reality visualization is displayed on augmented reality smart glasses.

8. A computer program product for visualizing unauthorized access or attempted unauthorized access of machines located on an industrial floor, the computer program product comprising one or more computer readable storage mediums having program code embodied therewith, the program code comprising programming instructions for:
capturing log files from a firewall monitoring traffic to and from the machines located on the industrial floor;
analyzing the log files from the firewall to identify a behavior used in accessing or attempting to access one or more machines of the machines located on the industrial floor;
analyzing a knowledge base for unauthorized access tactics; and
creating an augmented reality visualization to illustrate an unauthorized access tactic being performed on the one or more machines located on the industrial floor in response to the identified behavior being associated with the unauthorized access tactic within a threshold degree of similarity based on the analysis of the knowledge base.

9. The computer program product as recited in claim 8, wherein the program code further comprises the programming instructions for:
analyzing log files from the one or more machines located on the industrial floor to identify operational parameters.

10. The computer program product as recited in claim 9, wherein the program code further comprises the programming instructions for:
creating the augmented reality visualization to illustrate the unauthorized access tactic being performed on the one or more machines located on the industrial floor using the identified operational parameters.

11. The computer program product as recited in claim 8, wherein the program code further comprises the programming instructions for:
creating one or more avatars of a security hacker and/or a detected malware; and
illustrating the unauthorized access tactic being performed on the one or more machines located on the industrial floor in the augmented reality visualization using the created one or more avatars.

12. The computer program product as recited in claim 11, wherein the program code further comprises the programming instructions for:
identifying a remedial action to address the unauthorized access tactic being performed on the one or more machines located on the industrial floor using the knowledge base; and
illustrating the identified remedial action to address the unauthorized access tactic being performed on the one or more machines in the augmented reality visualization.

13. The computer program product as recited in claim 8, wherein the program code further comprises the programming instructions for: receiving feedback regarding the augmented reality visualization; and
updating the knowledge base for unauthorized access tactics based on the feedback.

14. The computer program product as recited in claim 8, wherein the augmented reality visualization is displayed on augmented reality smart glasses.

15. A system, comprising:
a memory for storing a computer program for visualizing unauthorized access or attempted unauthorized access of machines located on an industrial floor; and
a processor connected to the memory, wherein the processor is configured to execute program instructions of the computer program comprising:
capturing log files from a firewall monitoring traffic to and from the machines located on the industrial floor;
analyzing the log files from the firewall to identify a behavior used in accessing or attempting to access one or more machines of the machines located on the industrial floor;
analyzing a knowledge base for unauthorized access tactics; and
creating an augmented reality visualization to illustrate an unauthorized access tactic being performed on the one or more machines located on the industrial floor in response to the identified behavior being associated with the unauthorized access tactic within a threshold degree of similarity based on the analysis of the knowledge base.

16. The system as recited in claim 15, wherein the program instructions of the computer program further comprise:
analyzing log files from the one or more machines located on the industrial floor to identify operational parameters.

17. The system as recited in claim 16, wherein the program instructions of the computer program further comprise:
creating the augmented reality visualization to illustrate the unauthorized access tactic being performed on the one or more machines located on the industrial floor using the identified operational parameters.

18. The system as recited in claim 15, wherein the program instructions of the computer program further comprise:
creating one or more avatars of a security hacker and/or a detected malware; and
illustrating the unauthorized access tactic being performed on the one or more machines located on the industrial floor in the augmented reality visualization using the created one or more avatars.

19. The system as recited in claim 18, wherein the program instructions of the computer program further comprise:
identifying a remedial action to address the unauthorized access tactic being performed on the one or more machines located on the industrial floor using the knowledge base; and
illustrating the identified remedial action to address the unauthorized access tactic being performed on the one or more machines in the augmented reality visualization.

20. The system as recited in claim 15, wherein the program instructions of the computer program further comprise:
receiving feedback regarding the augmented reality visualization; and
updating the knowledge base for unauthorized access tactics based on the feedback.
